(19) United States
(12) Patent Application Publication
(10) Pub. No.: US 2021/0381720 A1
(43) Pub. Date: Dec. 9, 2021

(54) APARATUS FOR WATER PURIFYING AND DEHUMIDIFYING WITH AIR PURIFYING SYSTEM

(71) Applicant: NAIN CO, LTD., Chungcheongnam-do (KR)

(72) Inventor: Chae Won KIM, Chungcheongnam-do (KR)

(21) Appl. No.: 17/240,310

(22) Filed: Apr. 26, 2021

(30) Foreign Application Priority Data
Jun. 9, 2020 (KR) 10-2020-0069464

(51) Int. Cl. F24F 13/22; F24F 13/28; F24F 1/0358; F24F 1/0378; F24F 1/04

(52) U.S. Cl. CPC F24F 13/222; F24F 13/28; F24F 1/0358; F24F 2221/125; F24F 1/04; F24F 2013/228; F24F 2013/227; F24F 1/0378

(57) ABSTRACT

An apparatus for water purifying and dehumidifying with an air purifying system purifies air and purifies condensate water produced by dehumidification such that the condensate water can be used as drinkable water, as a single product, whereby various functions are given to one product. Accordingly, there is an effect that the manufacturing cost of the product is reduced and expenses by customers are decreased, whereby it is possible to improve competitiveness of the product in terms of practical use.

### BACKGROUND

The present disclosure relates to an apparatus for water purifying and dehumidifying with an air purifying system and, more particularly, to an apparatus for water purifying and dehumidifying with an air purifying system that purifies air and purifies condensate water produced by dehumidification such that the condensate water can be used as drinkable water, as a single product.

Generally, in water shortage countries such as China, the reliability of drinking water directly consumed by people is low. In addition, in such water shortage countries, the primary raw water itself for operating the water purifier is insufficient and the raw water is severely polluted. There is a widespread sense of distrust due to a contamination of the primary raw water, a concern about various chemicals injected during purification treatment, and a distrust about cleanliness of the raw water supply pipe.

In the case of China among these water shortage countries, according to the report on the ‘analysis of the current status of the China water purifier market’, a water pollution in China is very serious, and there have been an average of 1,700 water pollution accidents per year in the last 10 years. In particular, as a result of a survey of 4,896 groundwater supervision and management facilities in 202 cities in China, it was found that more than 61.5% of urban groundwater was triangularly contaminated. Also, in the case of the water quality of drinking water sources in urban areas in China, 11% of reservoirs, 70% of lakes, and 60% of groundwater were found to be below the standard for drinking water, and more than 70% of the 7 major basins, which are major management areas, were found to be contaminated.

Therefore, a large-scale investment is required primarily for the development and management of such drinking water sources, and the burden of purchasing cost for drinking water is very large. Moreover, frequent breakdowns and repair costs of water purifiers, that directly use the contaminated primary water are also increased.

In addition, the demand for air purifiers has been explosively increased due to the fine dust and the reduction of air quality owing to the environmental pollutions, and the demand for air purifiers in general homes or indoors is very high. Moreover, since the water purifier is also installed indoors, the cost of installing these products in the home is also burdensome. Furthermore, the indoor space becomes narrow due to the installation of these products. In particular, since the water purifier must always be installed along a water supply line through which water can be supplied, there is a restriction on installation thereof.

Therefore, there is a growing demand for convergence products that reduce the inconvenience caused by the use of such conventional water purifiers and air purifiers, collect the moisture in the atmosphere without purifying through a separate water supply line so as to purify the air with dehumidification, and finally purify the collected moisture to drink it.

### PATENT LITERATURE

Patent Literature: Korean Patent Registration No. 10-1466249 (Nov. 21, 2014)

### SUMMARY OF THE INVENTION

The present disclosure has been made in an effort to solve the problems described above and an objective of the present disclosure is to achieve both of air purification and water purification by moving to a place where it is required to improve the quality of air without moving along a water supply line by suctioning and purifying air and collecting water container in the air such that the water can be used as drinkable water, using a single product.

According to an aspect of the invention to achieve the object described above, there is provided an apparatus for water purifying and dehumidifying with an air purifying system, the apparatus including: a case having an inlet on a first side and an outlet on a second side; an air purifier installed behind the inlet and purifying air flowing inside through the inlet; a dehumidifier installed behind the air purifier and storing condensate water by collecting water contained in air that has passed through the air purifier; a ventilation fan installed behind the dehumidifier, suctioning air flowing inside from the inlet, and discharging the air to the outlet; and a water purifier purifying water stored in the dehumidifier, wherein the dehumidifier includes: several thermoelectric elements installed in a longitudinal direction; a cooler installed on first sides of the thermoelectric elements and condensing water in air flowing inside through the inlet on the surface thereof; a heat dissipater installed on second sides of the thermoelectric elements and dissipating heat; and a condensate water tank storing condensate water produced by the cooler.

Preferably, the water purifier includes: an air purification filter installed behind the inlet and removing dirt in air; and an air quality measurer installed on a first side of the case and measuring the air quality of the atmosphere.

Preferably, the water purifier includes: a water purification filter filtering out dirt in condensate water by transferring condensate water stored in the condensate water tank through a condensate water transfer pump; a purified water tank storing water purified through the water purification filter; an assistant purified water tank to which water stored in the purified water tank moves when the water stored in the purified water tank exceeds a predetermined water level; and a heat pipe having a first end being in contact with the inside of the assistant purified water tank and a second end being in contact with the heat dissipater, and heat from the heat dissipater is dissipated by coming in contact with the surface of the water stored in the assistant purified water tank through the heat pipe.

Preferably, the heat dissipater includes a heat dissipation body vertically formed to have a predetermined length, several thermoelectric elements are longitudinally attached to both sides facing each other of the heat dissipation body, so heat from the first sides of the thermoelectric elements is absorbed into the heat dissipation body; the cooler includes a cooling plate bent in a zigzag pattern, several cooling plates are longitudinally attached to the second sides of the thermoelectric elements, so cooling heat from the second sides of the thermoelectric elements transfers to the surfaces of the cooling plate, whereby water in air coming in contact with the surfaces condensates; and the heat dissipation body is inclined at a predetermined angle toward the ventilation fan, whereby water condensing on the surfaces of the cooling plate moves in the inclination direction and drops to the condensate water tank.

Preferably, the heat dissipation body is made of an aluminum material, a transfer channel through which fluid is transferred is longitudinally formed in a zigzag pattern in the heat dissipation body, and an intake hole and a discharge hole connected to the transfer channel are formed at both longitudinal ends of the heat dissipation body.

Preferably, connection ports for coupling water circulation pipes coming from the water purifier are fastened to the intake hole and the discharge hole, respectively; the connection ports each include an insert body having an outer diameter corresponding to inlets of the intake hole and the discharge hole and forcibly fitted in the intake hole and the discharge hole, a guide flange extending from the outer surface of the insert body and fastened by bolts in close contact with the outer surfaces of the inlets of the intake hole and the discharge hole, and a fastening body extending from the guide flange and coupled to the water circulation pipe on the outer surface; and the insert body is formed such that the outer diameter thereof increases from an end inserted in the intake hole and the discharge hole to the other side, and an O-ring groove for installing an O-ring is formed on the outer surface of the insert body.

Preferably, moving wheels are installed on the bottom of the case.

### BRIEF DESCRIPTION OF THE DRAWINGS

The above and other objects, features and advantages of the present invention will be more apparent from the following detailed description taken in conconfluence with the accompanying drawings, in which:

FIG. 1 is a view schematically showing the configuration of an apparatus for water purifying and dehumidifying with an air purifying system according to an embodiment of the present disclosure;

FIG. 2 is a structural view schematically showing a heat dissipation structure of a heat dissipater according to an embodiment of the present disclosure;

FIG. 3 is a view showing the installation state of thermoelectric elements according to another embodiment of the present disclosure;

FIG. 4 is a view showing the installation state of a dehumidifier according to another embodiment;

FIG. 5 is a view schematically showing a heat dissipation structure of a heat dissipater according to another embodiment of the present disclosure; and

FIG. 6 is a cross-sectional view showing the state when a connection port according to another embodiment of the present disclosure is installed on the heat dissipater.

[Reference Signs List]

| | | |
|---|---|---|
| 100: case | 110: inlet | 120: outlet |
| 130: moving wheel | 200: air purifier | |
| 210: air purification filter | | |
| 220: air quality measurer | | |
| 300: dehumidifier | 310: thermoelectric element | |
| 320: cooler | 321: cooling plate | |
| 330: heat dissipater | 331: heat dissipation body | |
| 332: transfer channel | 333: intake hole | 334: discharge hole |
| 340: condensate water tank | | |
| 400: ventilation fan | 500: water purifier | |
| 510: water purification filter | | |
| 520: condensate water transfer pump | | |
| 530: purified water tank | | |
| 540: assistant purified water tank | | |
| 550: heat pipe | 560: water circulation pipe | |
| 600: connection port | 610: insert body | |
| 611: O-ring groove | 612: O-ring | |
| 620: guide flange | 630: fastening body | |
| 640: transfer hole | | |

### DETAILED DESCRIPTION OF THE PREFERRED EMBODIMENT

Hereinafter, preferred embodiments of the invention will be described in more detail with reference to the accompanying drawings.

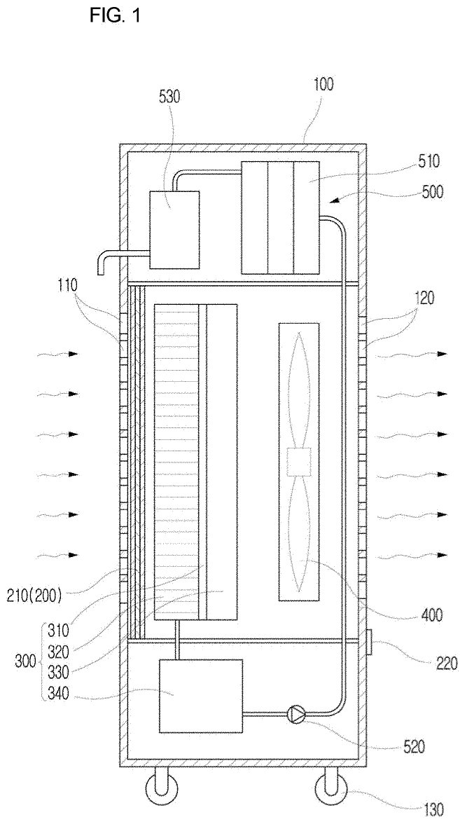

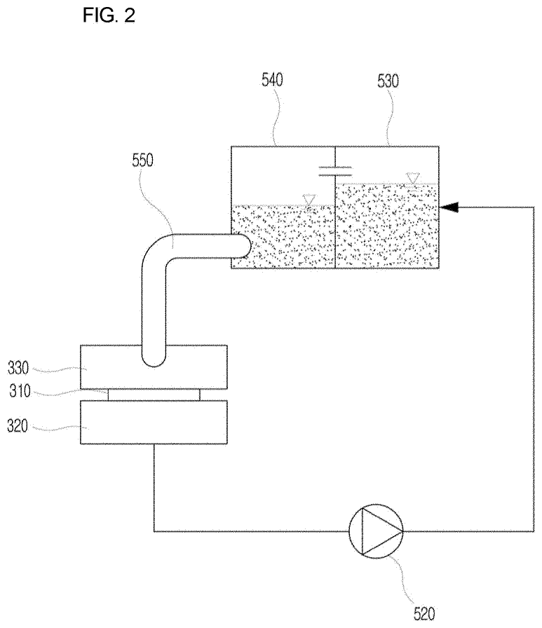

FIG. 1 is a view schematically showing the configuration of an apparatus for water purifying and dehumidifying with an air purifying system according to an embodiment of the present disclosure and FIG. 2 is a structural view schematically showing a heat dissipation structure of a heat dissipater according to an embodiment of the present disclosure.

Referring to the figures, an apparatus for water purifying and dehumidifying with an air purifying system according to an embodiment of the present disclosure includes a case (100), an air purifier (200) installed in the case (100), a dehumidifier (300), a ventilation fan (400), and a water purifier (500).

The case (100), which is made of metal, is manufactured by bending a metal plate in a box shape such that an accommodation space is formed therein, and has several inlets (110) formed through a side to enable external air to flow inside and several outlets (120) formed through another side to enable the air flowing inside through the inlets to be discharged after undergoing a dehumidification and purification process. Moving wheels (130) are installed on the bottom of the case (100), thereby improving mobility such that the case (100) can easily move on the ground, if necessary.

The air purifier (200) is installed behind the inlets (110) and purifies the air flowing inside through the inlets (110). The air purifier (200) includes an air purification filter (210) adsorbing dirt in the air like a carbon filter, HEPA filter etc. installed behind the inlets, and an air quality measurer (220) installed on a side of the case (100) and controlling operation of the air purifier (200) by measuring the air quality of the atmosphere.

The dehumidifier (300) is installed behind the air purifier (200) and condensates and collects water contained in the air that has passed through the air purification filter (210) to produce condensate water. In the present disclosure, the dehumidifier (300) uses a thermoelectric element (310) to achieve environment-friendly condensation and dehumidification beyond the cooling method that uses an evaporator, a condenser, and a compressor in the related art.

In more detail, the dehumidifier (300) of the present disclosure includes: several thermoelectric elements (310) longitudinally installed up and down along the inlets (110); a cooler (320) installed in close contact with first sides of the thermoelectric elements (310) and condensing the water contained in the air flowing inside through the inlets (110) on a cold surface by absorbing cooling heat generated by the thermoelectric elements (310); a heat dissipater (330) installed in close contact with second sides of the thermoelectric elements (310) and dissipating heat generated through the other sides of the thermoelectric elements (310); and a condensate water tank (340) storing the condensate water produced by the cooler (320).

The ventilation fan (400) is installed behind the dehumidifier (300), enabling air to flow inside from the inlets (110). The inflow air is filtered through the air purification filter (210), and then the water in the air condenses through the dehumidifier (300), and the air is discharged to the outside through the outlets (120).

The water purifier (500) purifies the condensate water stored in the condensate water tank (340) of the dehumidifier (300) to make the water be drinkable. In the present disclosure, the water purifier (500) further includes a water purification filter (510), a purified water tank (530), an assistant purified water tank (540), and a heat pipe (550).

The water purification filter (510) transfers the condensate water stored in the condensate water tank (340) installed at the lower portion in the case (100) to the top of the case (100) through a condensate water transfer pump (520) so that dirt in the condensate water is filtered out. The water purification filter (510) may purify water in several steps composed of a primary carbon filter, a secondary ultra filtration filter, and a third membrane filter.

The purified water tank (530), which stores the water purified through the water purification filter (510), may be equipped with a separate UV sterilizer so that the stored water is sterilized. A water level sensor is installed at the purified water tank (530) so that the water in the purified water tank (530) is sent to the assistant purified water tank (540) when the water stored in the purified water tank (530) exceeds a predetermined water level. Sending water to the assistant purified water tank (540) may be achieved in various ways such as using overflow or a shutoff valve.

As described above, the present disclosure is operated for dehumidification by the thermoelectric elements (310). It is required to minimize the temperature difference between the heat dissipater (330) and the cooler (320) on the thermoelectric elements (310) in order to increase a cooling rate, minimize power consumption, improve the durability of the product, and maximize the cooling-condensing ability.

Accordingly, in an embodiment of the present disclosure, the heat pipe (550) is installed to reduce the heat generation temperature difference by transferring the heat from the heat dissipater (330) to the assistant purified water tank (540).

The heat pipe (550) has an end disposed inside the assistant purified water tank 540 to be in contact with the water stored in the assistant purified water tank (540) and another end being in contact with the heat dissipater (330) absorbing the heat generated by the thermoelectric elements (310) such that the heat from the heat dissipater (330) comes in contact with the surface of the water stored in the assistant purified water tank (540) through the heat pipe (550). Accordingly, the heat dissipater (330) dissipates heat while heat transfers to the inside of the assistant purified water tank (540) by the heat pipe (550) without operating a specific circulation pump. The water in the purified water tank (530) is cold water cooled by the cooler (320) and the water in the assistant purified water tank (540) changes into warm water by exchanging heat, so cold water and warm water can be separately supplied to a user.

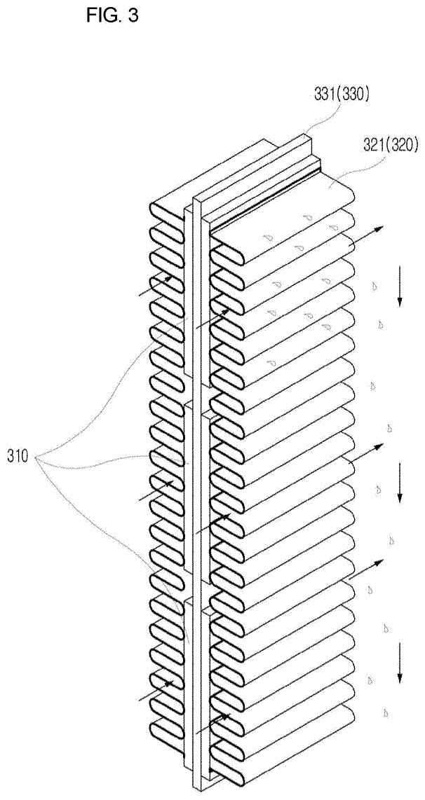

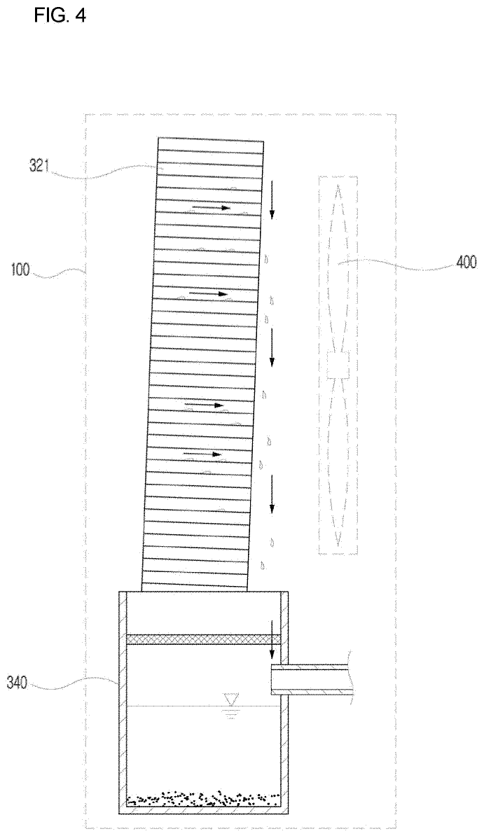

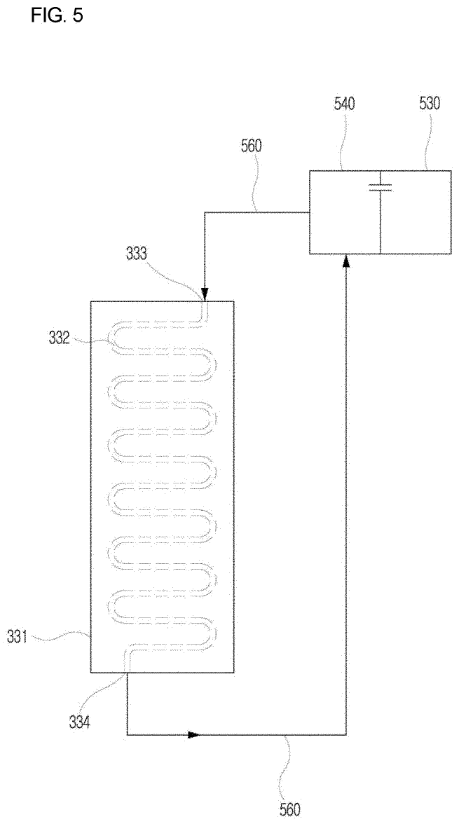

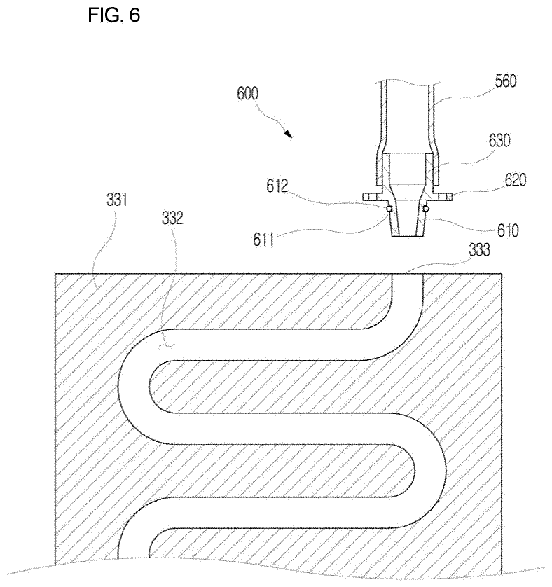

FIG. 3 is a view showing the installation state of thermoelectric elements according to another embodiment of the present disclosure, FIG. 4 is a view showing the installation state of a dehumidifier according to another embodiment, FIG. 5 is a view schematically showing a heat dissipation structure of a heat dissipater according to another embodiment of the present disclosure, and FIG. 6 is a cross-sectional view showing the state when a connection port according to another embodiment of the present disclosure is installed on the heat dissipater.

Referring to the figures, the heat dissipater (330) in another embodiment of the present disclosure includes a heat dissipation body (331) vertically elongated to a predetermined distance in the case (100), and several thermoelectric elements (310) are attached to both sides facing each other of the heat dissipation body (331). Heat generated from first sides of the thermoelectric elements (310) is absorbed into the heat dissipation body (331), and the heat dissipation body (331) is made of an aluminum material having high thermal conductivity to absorb a lot of heat.

In another embodiment of the present disclosure, the cooler (320) includes a cooling plate (321) bending in a zigzag pattern, and the cooling plate (321) is attached by a predetermined length on second sides of the thermoelectric elements (310) longitudinally installed. Cooling heat generated from the second sides of the thermoelectric elements (310) is absorbed into the cooling plate (321), whereby the surface of the cooling plate (321) cools and the water in the external air being in contact with the surface condenses on the surface of the cooling plate (321).

Further, in another embodiment of the present disclosure, as shown in FIG. 4, the upper end of the heat dissipation body (331) is inclined at a predetermined angle toward the ventilation fan (400), whereby the water condensing on the surface of the cooling plate (321) installed on the heat dissipation body (331) condenses at the end while moving in the inclination direction by gravity. Accordingly, drops of the water can quickly drop into the condensate water tank (340).

Further, the heat dissipation body (331) is made of aluminum metal having high thermal conductivity, as described above. A transfer channel (332) through which a heat exchange fluid moves is formed longitudinally in a zigzag pattern in the heat dissipation body (331) to quickly decrease the temperature of heat absorbed by heat exchange by the heat exchange fluid. An intake hole (333) and a discharge hole (334) that communicate with the transfer channel (332) are formed on both longitudinal end surfaces of the heat dissipation body (331). Water circulation pipes (560) connected to the intake hole (333) and the discharge hole (334), respectively, are connected to the assistant purified water tank (540) so that the water stored in the assistant purified water tank (540) circulates through the transfer channel (332) in the heat dissipation body (331) through the water circulation pipe (560).

Connection ports (600) for coupling the water circulation pipes (560) are fastened to the intake hole (333) and the discharge hole (334), respectively. The connection ports (600) are made of a metal material stronger than the aluminum material and include an insert body (610) that is inserted in the hole to improve cohesion with the heat dissipation body (331) and prevent leakage and also include a guide flange (620) and a fastening body (630).

The insert body (610) has an end having an outer diameter corresponding to the size of the inlets of the intake hole (333) and the discharge hole (334) and is formed such that the outer diameter gradually increases toward the other side from the end inserted in the intake hole (333) and the discharge hole (334). Accordingly, when the insert body (610) is inserted in the intake hole (333) and the discharge hole (334), the inner sides of the intake hole (333) and the discharge hole (334) formed in the heat dissipation body (331) made of a soft material expand such that the insert body (610) is forcibly fitted. As described above, as the insert body (610) is forcibly fitted in the heat dissipation body (331), the force coupling to the heat dissipation body (331) is improved without loosening at the joint. Further, an O-ring groove (611) for installing an O-ring (612) is formed on the outer surface of the insert body (610), so when the insert body (610) is forcibly fitted, the O-ring (612) is compressed, thereby increasing the sealing force to prevent fluid from leaking to the outside.

The guide flange (620) extends from the outer surface of the insert body (610) and is fastened by bolts in close contact with the outer surface of the inlets of the intake hole (333) and the discharge hole (334). The guide flange (620) prevents the insert body (610) fitted in the heat dissipation body (331) from being pulled out due to long-period vibration such as the operation of the ventilation fan 400 in the product.

The fastening body (630) extends from the guide flange (620) and the water circulation pipe (560) is fastened to the outer surface thereof, whereby transfer holes (640) through which water is transferred toward the insert body (610) from the fastening body (630) extend to each other. The transfer holes (640) decrease in diameter toward the insert body (610) from the fastening body (630) such that water is transferred to the transfer channel (332) through the intake hole (333) at a high flow speed.

According to the present disclosure, the apparatus purifies air and purifies condensate water produced by dehumidification such that the condensate water can be used as drinkable water, as a single product, whereby various functions are given to one product. Accordingly, there is an effect that the manufacturing cost of the product is reduced and expenses by customers are decreased, whereby it is possible to improve competitiveness of the product in terms of practical use.

Further, there is an effect that the apparatus can be operated anywhere without limitation on place because it is not required to separately supply water to be purified, and it is possible to increase convenience of use by improving indoor mobility because moving wheels are installed on the bottom.

Further, there is an effect that since dehumidification is performed using thermoelectric elements, there is no need for a specific refrigerant, so environment contamination can be reduced.

While the present invention has been described with respect to the specific embodiments, it will be apparent to those skilled in the art that various changes and modifications may be made without departing from the spirit and scope of the invention as defined in the following claims.

What is claimed is:

1. An apparatus for water purifying and dehumidifying with an air purifying system, the apparatus comprising:
a case having an inlet on a first side and an outlet on a second side;
an air purifier installed behind the inlet and purifying air flowing inside through the inlet;
a dehumidifier installed behind the air purifier and storing condensate water by collecting water contained in air that has passed through the air purifier;
a ventilation fan installed behind the dehumidifier, suctioning air flowing inside from the inlet, and discharging the air to the outlet; and
a water purifier purifying water stored in the dehumidifier,
wherein the dehumidifier includes:
several thermoelectric elements installed in a longitudinal direction;
a cooler installed on first sides of the thermoelectric elements and condensing water in air flowing inside through the inlet on the surface thereof;
a heat dissipater installed on second sides of the thermoelectric elements and dissipating heat; and
a condensate water tank storing condensate water produced by the cooler.

2. The apparatus of claim 1, wherein the water purifier includes:
an air purification filter installed behind the inlet and removing dirt in air; and
an air quality measurer installed on a first side of the case and measuring the air quality of the atmosphere.

3. The apparatus of claim 1, wherein the water purifier includes:
a water purification filter filtering out dirt in condensate water by transferring condensate water stored in the condensate water tank through a condensate water transfer pump;
a purified water tank storing water purified through the water purification filter;
an assistant purified water tank to which water stored in the purified water tank moves when the water stored in the purified water tank exceeds a predetermined water level; and
a heat pipe having a first end being in contact with the inside of the assistant purified water tank and a second end being in contact with the heat dissipater, and
heat from the heat dissipater is dissipated by coming in contact with the surface of the water stored in the assistant purified water tank through the heat pipe.

4. The apparatus of claim 1, wherein the heat dissipater includes
a heat dissipation body vertically formed to have a predetermined length, several thermoelectric elements are longitudinally attached to both sides facing each other of the heat dissipation body, so heat from the first sides of the thermoelectric elements is absorbed into the heat dissipation body;
the cooler includes a cooling plate bent in a zigzag pattern, several cooling plates are longitudinally attached to the second sides of the thermoelectric elements, so cooling heat from the second sides of the thermoelectric elements transfers to the surfaces of the cooling plate, whereby water in air coming in contact with the surfaces condensates; and
the heat dissipation body is inclined at a predetermined angle toward the ventilation fan, whereby water condensing on the surfaces of the cooling plate moves in the inclination direction and drops to the condensate water tank.

5. The apparatus of claim 4, wherein the heat dissipation body is made of an aluminum material, a transfer channel through which fluid is transferred is longitudinally formed in a zigzag pattern in the heat dissipation body, and an intake hole and a discharge hole connected to the transfer channel are formed at both longitudinal ends of the heat dissipation body.

6. The apparatus of claim 5, wherein connection ports for coupling water circulation pipes coming from the water purifier are fastened to the intake hole and the discharge hole, respectively;
the connection ports each include an insert body having an outer diameter corresponding to inlets of the intake hole and the discharge hole and forcibly fitted in the intake hole and the discharge hole, a guide flange extending from the outer surface of the insert body and fastened by bolts in close contact with the outer surfaces of the inlets of the intake hole and the discharge hole, and a fastening body extending from the guide flange and coupled to the water circulation pipe on the outer surface; and
the insert body is formed such that the outer diameter thereof increases from an end inserted in the intake hole and the discharge hole to the other side, and an O-ring groove for installing an O-ring is formed on the outer surface of the insert body.

7. The apparatus of claim 1, wherein moving wheels are installed on the bottom of the case.
